(19) United States
(12) Patent Application Publication
(10) Pub. No.: US 2007/0022380 A1
(43) Pub. Date: Jan. 25, 2007

(54) Context aware task page

(75) Inventors: Tanya L. Swartz, Seattle, WA (US); Gregory P. Baribault, Lynnwood, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/185,505

(22) Filed: Jul. 20, 2005

(51) Int. Cl. G06F 9/00

(52) U.S. Cl. 715/733; 715/747; 715/765

(57) ABSTRACT

A mobile device operates in several contexts, where a context is specific to a particular operation of the mobile device. The context can include particular activities performed by the mobile device. Depending on the context, a specific context aware task page which includes a specific list of tasks is provided.

### BACKGROUND

Mobile devices such as personal digital assistants (PDA), cellular telephones, and laptop computers run numerous application programs or applications. Such applications include time management (i.e., schedule/calendar), web browsing, mapping, word processing, audio/video reproduction, etc. For each application, corresponding tasks may be provided to a user of the mobile device. Therefore, there may be numerous applications and tasks available to the user. Typically the user is accessing their mobile device to perform a particularly task or tasks; however, the user may have to go through or navigate through a large list of tasks to find the particular tasks they want to accomplish.

Furthermore, a screen on a mobile device is relatively small, sometimes it is no larger than a few inches diagonally, making it difficult to view menus that support or call up the different applications or tasks. Furthermore, the relatively small size of the mobile device's screen limits the number of applications (i.e., icons representing the applications) and/or tasks that can be presented to the user.

The user interface of the mobile device may also be limited. Examples of user interfaces on mobile devices include scroll wheels and directional (i.e., arrow) devices. In certain mobile devices a condensed keyboard may be provided, where alphanumeric keys may be consolidated. In general, such user interfaces fall short in regards to ease of use compared to a full size QWERTY keyboard and mouse. The limited user interface of mobile devices tends to make it even more difficult to call up different applications and/or tasks.

The user may be presented with icons or menu items representing the numerous applications and/or tasks that are available. The user chooses from the multiple icons or menu items to select one or a select number of applications and/or tasks. Typically, this act of choosing applications and/or tasks is repeated each time the mobile device is turned on, which can become very inconvenient considering the size of the mobile device screen and the user interface.

Calling up applications and/or tasks, or navigating through the menus of a mobile device may not just be inconvenient, but may also be dangerous. A specific example is the situation where a user is driving a vehicle while using a mobile device. If the user desires to call up a specific application or task, the user may have to scroll through a menu and choose from specific applications, while manipulating the mobile device user interface and viewing the mobile device screen. The act of choosing particular applications and/or tasks can adversely distract the user from the task of driving the vehicle.

### SUMMARY

A mobile device operates in one of several contexts, where a context defines an operating condition of the mobile device. Based on the specific context, which is determined by one or more factors, a particular context aware task page that includes a list of tasks specific to the context is provided.

### BRIEF DESCRIPTION OF THE CONTENTS

The detailed description is described with reference to the accompanying figures. In the figures, the left-most digit(s) of a reference number identifies the figure in which the reference number first appears. The use of the same reference number in different figures indicates similar or identical items.

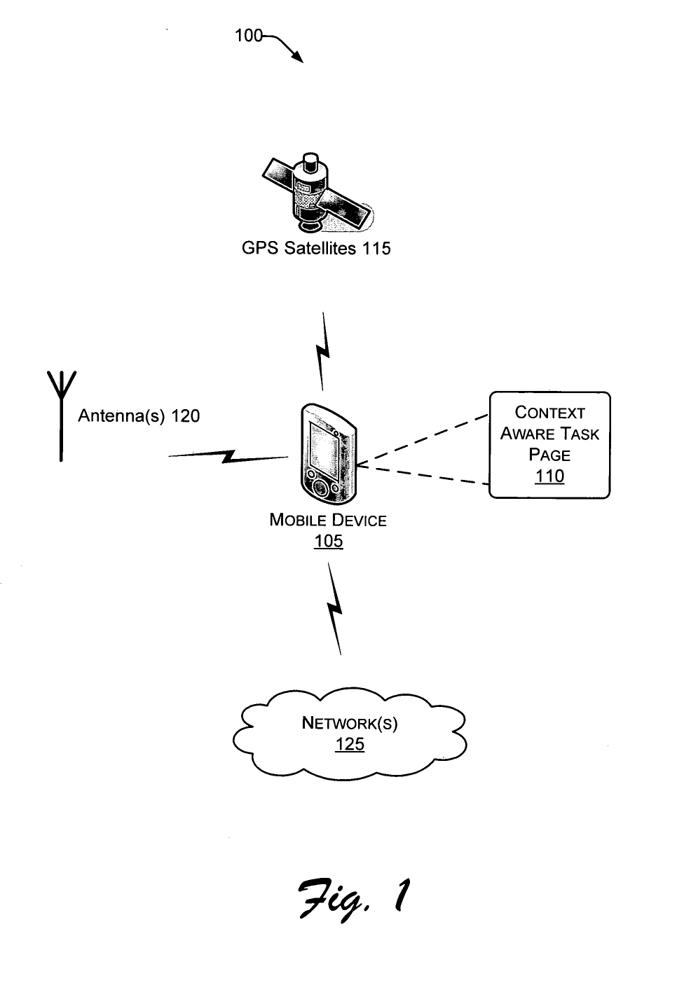

FIG. 1 is an illustration of a system that includes a mobile device that has a context aware task page of select tasks.

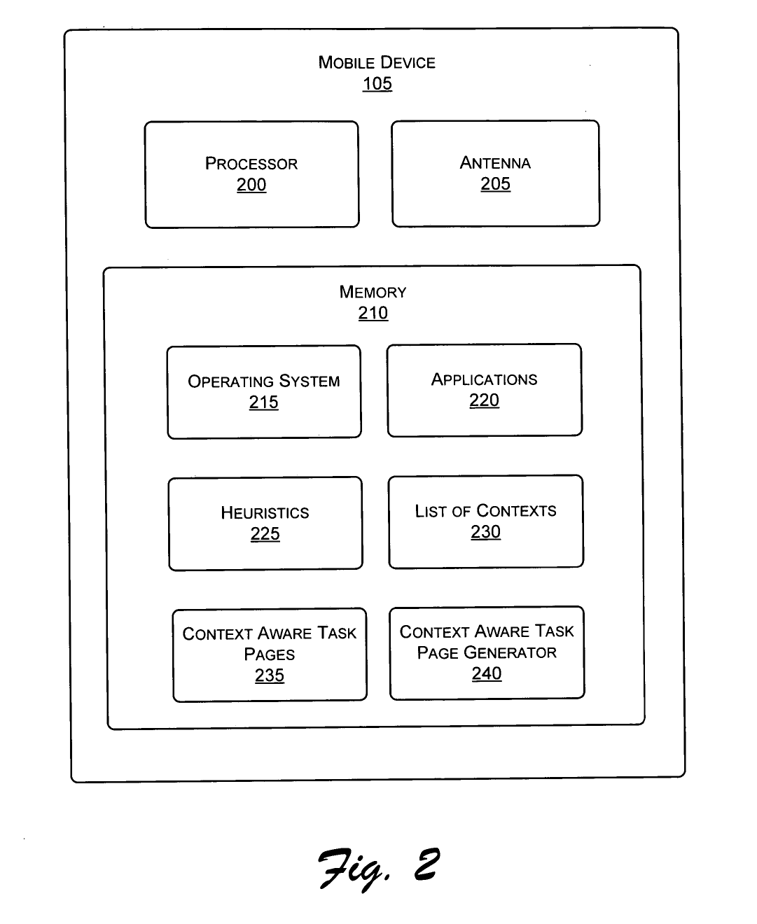

FIG. 2 is a block diagram of a mobile device that includes contest aware task pages and heuristics that call up a particular context aware task page.

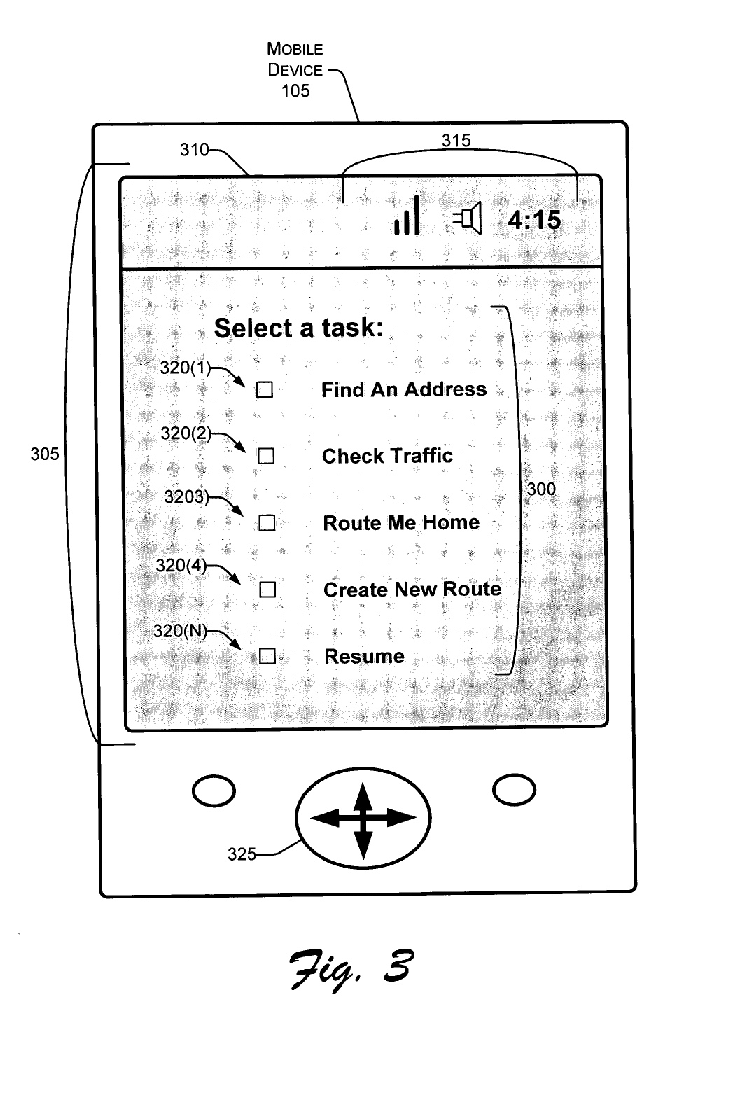

FIG. 3 is an illustration of a mobile device and a context aware task page listing specific tasks available to a user.

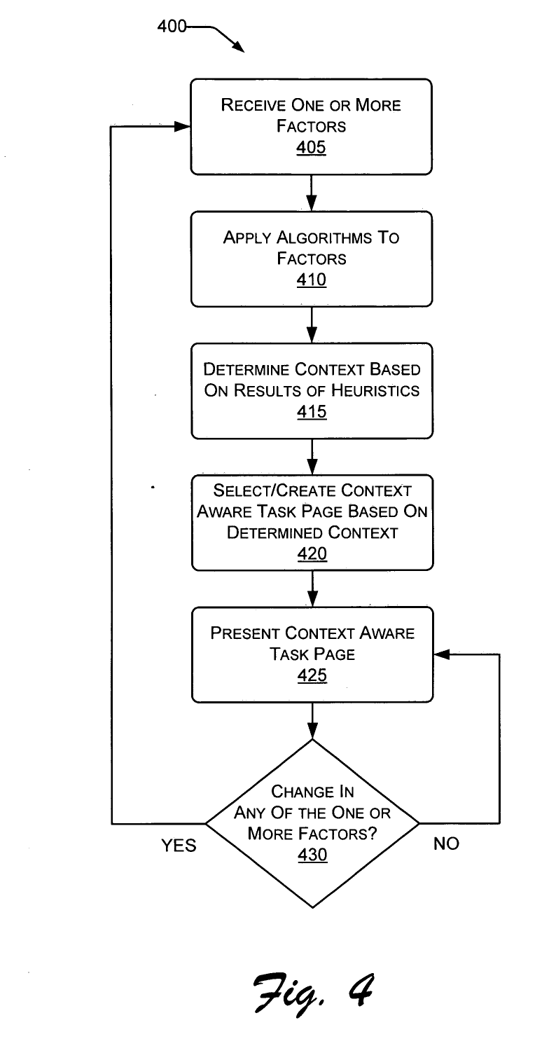

FIG. 4 is a flow diagram illustrating a process to provide a context aware task page.

### DETAILED DESCRIPTION

The following disclosure describes techniques in which a task page is presented to a user based on particular factors.

FIG. 1 shows a system 100 that includes a mobile device 105 that implements context aware task pages. In particular, the mobile device displays a context aware task page 110 of specific tasks to a user. The context aware task page 110 is displayed with little or no manipulation of the mobile device 105 by the user.

The mobile device 105 may be one of several computing devices that include personal digital assistants (PDA), cellular or mobile telephones, and wireless configured laptop computers. Mobile device 105 may be particularly configured with one or more wireless technologies such as IEEE 802.11 (e.g., “G”, “Pre-N”, including evolving and future standards), Bluetooth, global positioning system (GPS), general packet radio service (GPRS), and cellular telephone (which may include various standards such as code division multiple access, time division multiple access, personal communications services, etc.)

The context aware task page 110 includes a specific list of tasks or menu items directed to one or more application programs or applications. The context aware task page 110, and in particular its specific list of tasks, is called up or derived based on one or more conditions or factors. The factors can include time, date, location, particular applications that may be running on mobile device 105, etc.

The factors, weighed against one another and taken as a whole (i.e., heuristics applied to the factors), define a particular “context” in which the mobile device 105 is operating. An example of a context is when the mobile device 105 is the user driving a vehicle. When it is sensed or detected that the mobile device is in movement (movement or motion being a factor), heuristics in mobile device 105 determine that the context is the user driving a vehicle. Therefore, for the context of the user driving a vehicle, the context aware task page 110 may present a limited list of tasks to the user. The list of tasks is specific to applications that assist the user in driving, such as directional mapping, checking traffic, finding a particular address, etc. If a slower rate of movement of mobile device 105 is detected, the context may change to provide more tasks to the list. Another example of a context includes detecting when a user is on vacation—a factor being a time defined vacation activity on a calendar application on the mobile device 105. The context aware task page 110 presents tasks associated with a vacation, such as local mapping, local attractions, weather (i.e., links to weather related websites), etc.

Mobile device 105 may receive signals from multiple global GPS satellites 115. As it is well known, at least three signals from three different GPS satellites 115 are received in order to derive a location for mobile device 105. Therefore, by receiving signals from GPS satellites 115 and use of an internal mapping application, the mobile device 105 may determine its location. Furthermore, the use of GPS satellites 115 allows a detection as to whether mobile device 105 is stationary or moving (i.e., rate of speed is calculated using GPS satellites 115). Location of mobile device 105 is another factor that can determine the tasks that are listed by context aware task page 110. For example, if the location of mobile device 105 is detected at a user's home, home related tasks may be listed in context aware task page 110. Alternatively, the determined location may be the user's office, wherein work related tasks may be listed in context aware task page 110.

Mobile device 105 may send and receive communications with one or more mobile telephone or cellular antennas 120. Antennas 120 may be part of a cellular or PCS network (not shown), where such a network may include analog and digital systems and/or networks. Communication with antennas 120, and particularly to networks that connect to antennas 120, may also provide location and movement of mobile device 105. Furthermore, communication with such networks can provide access to various websites, allowing the mobile device 105 to receive information from such websites. Website information can include maps, weather, business locations, etc.

The mobile device 105 may further connect or communicate with one or more wireless networks 125, which include local area networks (LAN), wide area networks (WAN), etc. Networks 125 include multiple wireless access points (WAP) (not shown) that allow mobile device 105 to connect or communicate with network 125. Mobile device 105, the WAPs, and network 125 may implement one or more wireless technologies such as Bluetooth and various IEEE 802.11 standards (i.e., “G”, “Pre-N”, etc.). Connection with wireless networks 125 can also provide the mobile device 105 access to various websites and website information as described above.

FIG. 2 shows an exemplary mobile device 105 that provides a context aware task page, such as context aware task page 110. Mobile device 105 includes a central processing unit, controller, or processor 200. Mobile device 105 includes an antenna 205 to receive and/or send signals (i.e., communications) with GPS satellites 115, antenna(s) 120, and network(s) 125. Antenna 205 may be controlled or accessed (directly or indirectly) by processor 200.

Processor 200 is particularly configured to access and control a memory 210. The memory 210 includes various volatile and non-volatile memories, and includes read only memory (ROM) and random access memory (RAM). Memory 210 stores an operating system 215 and applications 220. Applications 220 include one or more application programs or applications that are run by operating system 215. Examples of applications include applications directed to calendars or scheduling, word processing, web browsing, worksheets, mapping, multimedia (audio/video), games, etc. The types and number of applications 220 can increase as new applications are provided. Each application in applications 220 may be identified to a user by a specific menu item or icon that is displayed in a context aware task page, such as context aware task page 110. In particular, the menu item or icon may be a task directed to a specific application. Running an application or applications may also define factors that determine tasks that are listed by the context aware task page. For example, a spreadsheet application may be running on mobile device 105. Combined with a determination that the mobile device 105 is located at the user's office, work related tasks may be listed by the context aware task page.

Memory 210 includes heuristics 225. Using various factors, heuristics 225 determines a context. Heuristics 225 can include one or more algorithms that consider multiple factors that define a current context of mobile device 105. Exemplary algorithms include algorithms that assign particular weights to particular factors, where certain factors may be more important than others. Based on the current context determined by heuristics 225, a context is chosen from a list of contexts 230. The list of contexts 230 includes particular contexts directed to operating conditions of the mobile device 105.

Based on the context chosen from the list of contexts 230, an application in applications 220 or the operating system 215 selects a context aware task page from a group of context aware task pages 230. The context aware task page may be selected and presented when the mobile device 105 is turned on. Furthermore, a different context aware task page may be selected and presented when heuristics 225 determines a change in the factors or when new or different factors are received indicating a different context. Alternatively, a context aware task page generator 240 may create a particular context aware task page.

In general, heuristics 225 determines a particular context in which the mobile device 105 is currently operating. An example provided above, is the context of driving a vehicle. Other exemplary contexts include a context based on a calendar event, such as the user being on vacation. If the user has a scheduled vacation on the calendar, heuristics 225 provides a context aware task page directed to task related to the vacation.

FIG. 3 shows a mobile device 105 and an exemplary context aware task page 300. Context aware task page 300 is displayed on a screen 305 of mobile device 105. The context aware task page 300 may be part of a desktop display or desktop 310, where desktop 310 includes other icons and/or menu items. In this example desktop 310 includes icons 315, which particularly include signal reception indicator bars, a volume icon, and time.

The context aware task page 300 includes a list of tasks 320(1) to 320(N). A user interface 325 of mobile device 105 allows the user to select from one of the tasks 320 of the context aware task page 300. Each of the tasks 320 is particular to an application stored in applications 220. In this example, context aware task page 300 is directed to a context of driving a vehicle, where each of the tasks 320 is particular to an application that may be associated with driving a vehicle.

Tasks that may be irrelevant to the context of driving a vehicle are not included in context aware task page 300, thus providing the user with a minimal list of tasks to choose from. This particular context aware task page 300 is determined by the factor of movement. As discussed above, if it is detected that mobile device 105 is moving, the context aware task page associated with the context of driving a vehicle is presented. Once movement is determined to cease (i.e., detection that mobile device 105 is stationary), a different context may be determined by heuristics 225 and a different context aware task page is selected and presented.

FIG. 4 shows a process 400 that provides a context aware task page for a mobile device. The process 400 is illustrated as a collection of blocks in a logical flow graph, which represent a sequence of operations that can be implemented in hardware, software, firmware, or a combination thereof. In the context of software, the blocks represent computer instructions that, when executed by one or more processors, perform the recited operations. Although described as a flowchart, it is contemplated that certain processes may take place concurrently or in a different order. The process may be implemented, for example, by the mobile device 105 as discussed in FIG. 2, although the process may be implemented by other architectures.

At block 405, one or more factors are received. The factors may be received by heuristics 225 of FIG. 2. The factors can include information derived from detecting that the mobile device is in motion, location of the mobile device, applications that are currently running on the mobile device, the time of day, etc. In certain cases, the factors are derived from applications, and in other cases the factors are derived from general operation of the mobile device where the general operation may be derived by an operating system (i.e., operating system 215) of the mobile device.

At block 410, one or more algorithms are applied to the factors. The algorithms may weigh a particular factor greater than other factors. In certain cases, if a particularly factor is present, it supersedes all the other factors. For example, if a factor related to movement of the mobile device is received, although other factors may be present, only the factor related to movement is considered. The algorithms may be particularly applied by heuristics 225.

At block 415, based on the results of the algorithms, a particular operating condition or context is determined. The context can particularly be determined by heuristics 225. Specific contexts may be included in list of contexts 230. Examples of contexts include driving a vehicle, working at the office, working at home, vacationing, etc.

At block 420, based on the context that is determined, a context aware task page is selected or created. The context aware task page may be selected form context aware task page 235, or a context aware task page may be created by context aware task page generator 240.

At block 425, the selected or created context aware task page is presented. In particular, the context aware task page may be presented in a desktop display such as desktop 310. The context aware task page includes a list of tasks that are specific to the current context. The context aware task page may be presented in a way to allow the user to select from the list of tasks.

If no changes in the one or more factors are detected (i.e., following the NO branch of block 430), at block 425 the existing context aware task page is presented. If a change is detected in any of the one or more factors (i.e., following the YES branch of block 430), at block 405, one or more factors are received or re-received, and a new context aware page is provided.

### Conclusion

The above-described methods and mobile device describe a context aware task page of select tasks to a user. Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
determining a context of a mobile device based on one or more factors; and
providing a context aware task page of a list of tasks specific to the context.

2. The method of claim 1 wherein the determining is performed by applying one or more algorithms to the factors.

3. The method of claim 1 wherein the factors are derived from applications running on the mobile device and from general operation of the mobile device.

4. The method of claim 1 wherein the providing the context aware task page is selecting the context aware task page from a group of context aware task pages.

5. The method of claim 1 wherein the providing the context aware task page is creating the context aware task page.

6. The method of claim 1 further comprising presenting the context aware task page on a desktop display of the mobile device.

7. The method of claim 1 further comprising selecting a context from a list of contexts, wherein the context aware task page is provided based on the selected context.

8. The method of claim 1 further comprising providing a new context aware task page if a change is detected in the one or more factors.

9. A mobile device comprising:
a processor;
heuristics run by the processor, to determine a context that defines an operating condition of the mobile device; and
a list of contexts run by the processor, from which the context is chosen.

10. The mobile device of claim 9 wherein the heuristics include one or more algorithms that consider multiple factors to determine the context.

11. The mobile device of claim 9 wherein a context aware task page is provided based on the context that is chosen.

12. The mobile device of claim 11 further comprising a list of context aware task pages run by the processor, from which the context aware task page is provided.

13. The mobile device of claim 11 further comprising a context aware task page generator run by the processor, from which the context aware task page is generated.

14. The mobile device of claim 11 wherein the context aware task page is provided by an operating system run by the processor.

15. The mobile device of claim 11 wherein the context aware task page is provided by an application run by the processor.

16. A computer computer-readable media comprising computer-executable instructions that, when executed, perform the steps comprising:
receiving one or more factors;
applying one or more algorithms to the one or more factors to determine a context; and
providing a list of tasks based on the determined tasks.

17. The computer-readable storage medium of claim 16 wherein the receiving is from one or more applications and or operation of a mobile device.

18. The computer-readable storage medium of claim 16 wherein the applying one or more algorithms weighs the factors.

19. The computer-readable storage medium of claim 16 wherein the providing is from a list of context aware task pages.

20. The computer-readable storage medium of claim 16 further comprising presenting the list of tasks to a user.
